(19) United States
(12) Patent Application Publication
(10) Pub. No.: US 2026/0265156 A1
(43) Pub. Date: Sep. 10, 2026

(54) COMPOSITION COMPRISING A EUTECTIC MIXTURE COMPRISING AN ALKYLTHIOPHOSPHORIC TRIAMIDE UREASE INHIBITOR

(71) Applicant: SPECIALTY OPERATIONS FRANCE, Lyon (FR)

(72) Inventors: Adegboyega Isaac Adeleye, Bristol, PA (US); Ahmed Alsayed, Bristol, PA (US); Denis Bendejacq, Bristol, PA (US); Jiamin Wu, Bristol, PA (US)

(73) Assignee: SPECIALTY OPERATIONS FRANCE, Lyon (FR)

(21) Appl. No.: 18/873,285

(22) PCT Filed: Jun. 9, 2023
(86) PCT No.: PCT/EP2023/065531

§ 371 Date: Dec. 9, 2024

Related U.S. Application Data
(60) Provisional application No. 63/350,493, filed on Jun. 9, 2022.

(30) Foreign Application Priority Data
Jun. 22, 2022 (EP) 22180487.5

(51) Int. Cl. C05G 3/90; C05G 5/23

(52) U.S. Cl. CPC C05G 3/90; C05G 5/23

(57) ABSTRACT

This invention relates to a composition comprising a eutectic mixture of an alkylthiophosphoric triamide and an additive, and methods for use thereof, to facilitate incorporation of said composition into solid state or liquid state agricultural compositions, in particular fertilizer formulations. The invention provides access to compositions having excellent chemical and physical stability, notably high temperature and low temperature stability, including at temperatures well below 0° C.

### TECHNICAL FIELD

The present invention relates to a composition comprising a urease inhibitor, in particular an alkylthiophosphoric triamide such as N-(n-butyl)thiophosphoric triamide (NBPT), useful for agricultural compositions and more particularly fertilizer formulations, and its manufacture. It also relates to the agricultural compositions which can be derived therefrom and their use.

### BACKGROUND ART

In the agrochemical industry, farmers use various fertilizers to impart macronutrients to plants either by application to the soil or application to plant leaves. Nitrogen, phosphorus, potassium, calcium, magnesium, and sulfur are macronutrients that must be supplied to the plants and soil manually by farmers. In many crops, the amount of nitrogen supplied is critical to the overall quality and growth of the crop. Nitrogen is typically supplied in the form of nitrogenous, i.e., nitrogen precursor-containing, fertilizer compounds, such as urea, ammonium nitrate, or ammonium phosphate fertilizer compounds. Due to the high water solubility of these salts, however, applied nitrogen may be lost due to run-off and leaching of the nitrogenous fertilizer compounds. Once applied, the nitrogenous fertilizer compounds are typically degraded, for example, by microorganisms present in the soil, to nitrogenous species such as NH₄⁺, NO₂⁻, NO₃⁻, and ammonia gas, that may be even more readily lost through evaporation, run-off, and leaching than the fertilizer compounds themselves. If degradation of the fertilizer compounds occurs at a rate that is faster than the nitrogenous degradation products can be used by the plants, then the nitrogen values in the degradation products are at increased risk of being lost.

Nitrification and/or urease inhibitors are of potential use in delaying degradation of fertilizer compounds and thereby reducing losses of nitrogenous degradation products that would otherwise occur in the absence of the inhibitors. The use of nitrification and/or urease inhibitors in combination with nitrogenous fertilizer compounds tends to increase the amount of time the nitrogen sources remain in the soil and available for absorption by the plants, which tends to increase the effectiveness of the fertilizers and positively impact crop yield and quality.

Aqueous end use fertilizer solutions are typically prepared in the field by diluting commercially available concentrated fertilizer compositions with water. Commonly used concentrated fertilizer compositions include concentrated ammonium nitrate compositions, such as, for example, UAN 18, UAN 28, UAN 30 and UAN 32.

Urease inhibitors can be used with a fertilizer (i.e., incorporated into a urea-containing fertilizer, e.g., urea and urea ammonium nitrate (UAN)) to slow the conversion of urea to ammonia gas and thus slow the loss of ammonia to volatilization, thus making ammonium available to plants in the soil for longer periods of time. The hydrolysis of urea is facilitated by urease enzyme present in the soil. In many crops, the amount of nitrogen supplied is critical to the overall quality and growth of the crop. Nitrogen is supplied in either urea or ammonium forms. Due to the high water solubility of these salts, however, much of the nitrogen applied is lost to run-off and leaching. In ammonium-based products, if the nitrogen is not lost due to leaching or run-off, then ammonium can bind to soil particles and be made available for the plant. Conversion occurring near the surface of the soil, however, does not allow for binding and this ammonia is lost to the atmosphere. Urease inhibitors are used to protect a farmer's investment in fertilizers by preventing the breakdown of urea by urease, the soil microbe responsible for converting urea to usable ammonia in the soil. This increases the amount of time the nitrogen remains in the soil and is available to the plant for absorption.

A typical urease inhibitor, alkyl thiophosphoric triamide (for example, N-(n-butyl)-thiophosphoric triamide or otherwise “NBPT”), however, faces drawbacks in its use as NBPT is extremely difficult to handle. NBPT is a sticky, waxy, heat and water sensitive material, which cannot be used in its solid form, as it is used at low concentrations making it difficult to evenly distribute on urea prills (i.e., large granules) and in soil. In order to evenly distribute the NBPT onto the urea, the NBPT should be dispersed into a carrier prior to being sprayed onto the urea. It is known (see for example U.S. Pat. No. 10,173,935) that the use of a solvent system containing the NBPT in a liquid solvent system is capable of distributing the NBPT into granular urea (e.g., urea prills) and into liquid fertilizers containing urea. By introducing the NBPT to liquid fertilizers containing urea (for example, urea-ammonium nitrate solutions or UAN) in a solvent system, the NBPT is capable of being better dispersed in the liquid fertilizer.

There is a very limited number of solvents available that can solubilize high amounts of NBPT. It has been already reported to use dimethylsulfoxide (DMSO) in order to solubilize N-(n-butyl)-thiophosphoric triamide (NBPT), see for example U.S. Pat. No. 10,597,338. DMSO however, has some drawbacks notably in terms of stability of the solutions obtained and the capability of carrying high loads of urease inhibitor over the whole applicable temperature range. U.S. Pat. No. 10,487,019 proposes phosphoric or thiophosphoric triamide compositions having a concentration range of 35 to 50 wt. % and comprising 5-30 wt % of specific glycol or glycol derivative and 20-50 wt. % of an amide solvent wherein the preferred solvent is N-Methylpyrrolidone, which is highly toxic. The exemplified compositions are described to maintain a homogeneous solution after storage at 0° C. for 14 days.

WO2017144698 discloses a method for the manufacture of a liquid composition essentially consisting of an organic solvent of the type glycol and a urease inhibitor of the type phosphoric triamide. The compositions are only able to maintain a low urease inhibitor load and they appear to crystallize at <−10° C. and do not appear to present a storage stability at that temperature.

### DESCRIPTION OF THE INVENTION

The invention now makes available a totally different concept allowing to improve the use of urease inhibitors, in particular those of the type alkylthiophosphoric triamide such as NBPT, in agricultural compositions and notably fertilizer compositions.

The invention first relates, in consequence, to a composition comprising a eutectic mixture of an alkylthiophosphoric triamide and an additive.

It has been found that the composition of the invention is useful to provide a range of advantageous agricultural compositions containing high amounts of urease inhibitor. Such compositions are usually stable homogeneous solutions at room temperature. The composition according to the invention allows to provide a carrier system having low toxicity. The invention provides access to compositions having excellent chemical and physical stability, notably high temperature and low temperature stability, including at temperatures well below 0° C.

In one embodiment, said additive present in the composition of the invention is a solid at 25° C.

In one embodiment, the alkylthiophosphoric triamide is N-(n-butyl)thiophosphoric triamide (NBPT).

In one embodiment, the additive comprises a quaternary ammonium compound, preferably one selected from tetraalkyl ammonium compounds, especially those in which one or more of the alkyl radicals comprise at least one hydroxy group.

In one embodiment, the quaternary ammonium compound is a salt.

In one embodiment, the quaternary ammonium compound is a choline derivative, preferably choline chloride.

In one embodiment, the weight ratio of alkylthiophosphoric triamide to additive is from 1:1 to 10:1, preferably from 2:1 to 5:1.

In one embodiment, the composition of the invention comprises a complex of N-(n-butyl)thiophosphoric triamide (NBPT) and choline chloride.

In one embodiment, the composition of the invention displays an at least meta-stable liquid state at 18° C.

In one embodiment, the composition of the invention displays a stable liquid state at 42° C., preferably from 42° C. to 53° C.

In one embodiment, the composition of the invention further comprises at least one liquid carrier.

In one embodiment, the liquid carrier is selected from alcohols, glycols and glycol derivatives, amines, amine alcohols, heterocyclic alcohols, cyrene, dimethyl lactamide, dibasic ester solvents, toluene, trialkyl phosphate solvents, in particular triethyl phosphate, methylbenzoate, and mixtures thereof.

In one embodiment, the liquid carrier comprises DL-1,2-Isopropylideneglycerol.

In one embodiment, the composition of the invention comprises or consists of from 25 to 29.9 wt. %, preferably from 27 to 29 wt. % of N-(n-butyl)thiophosphoric triamide (NBPT), from 4.5 wt. % to 8 wt. % preferably from 5 wt. % to 7 wt. % of choline chloride and more than 50 wt. %, and at most 70.5 wt. % of DL-1,2-Isopropylideneglycerol, relative to the total weight of the composition.

In one embodiment, the composition of the invention comprises or consists of from 30.0 to 35 wt. %, preferably from 30.5 to 33 wt. %, more preferably about 31 wt. % of N-(n-butyl)thiophosphoric triamide (NBPT), from 4.9 wt. % to 10 wt. % preferably from 7 wt. % to 8 wt. % more preferably about 7.5 wt. % of choline chloride and more than 40 wt. %, preferably at most 65.1 wt. % of DL-1,2-Isopropylideneglycerol, relative to the total weight of the composition.

In one embodiment, the liquid carrier comprises an aminoalcohol, preferably 3-amino-1-propanol.

In one embodiment, the composition of the invention comprises or consists of from 30.0 to 35 wt. %, preferably from 30.5 to 33 wt. %, more preferably about 31 wt. % of N-(n-butyl) thiophosphoric triamide (NBPT), from 4.9 wt. % to 10 wt. % preferably from 7 wt. % to 8 wt. % more preferably about 7.5 wt. % of choline chloride and more than 40 wt. % and at most 65.1 wt. % of 3-amino-1-propanol.

In one embodiment, the composition of the invention further comprises an additional liquid carrier.

In one embodiment, the additional liquid carrier comprises or consists of a (poly)alkylene ether, more preferably dipropylene glycol dimethyl ether.

In one embodiment, the composition of the invention contains 1 to 10 wt. %, preferably about 5 wt. % of dipropylene glycol dimethyl ether.

In one embodiment, the additional liquid carrier comprises or consists of an alkanol, more preferably 2-ethyl-1-hexanol.

In one embodiment, the composition of the invention contains 1 to 10 wt. %, preferably about 5 wt. % of 2-ethyl-1-hexanol.

In one embodiment, the composition of the invention remains flowable after keeping at a temperature of −10° C. for 3 weeks.

The present invention also relates to an agricultural composition comprising a nitrogenous fertilizer, an alkylthiophosphoric triamide and an additive in proportions for which they form a eutectic mixture, preferably in accordance with anyone of the embodiments described in the present description.

The present invention also relates to a liquid end-use composition comprising a liquid nitrogenous fertilizer and the composition according the invention.

The present invention also relates to a solid end-use composition comprising a solid nitrogenous fertilizer and the composition according to the invention.

In one embodiment, the solid end-use composition comprises a core of nitrogenous fertilizer and a coating comprising the composition according to the invention.

The present invention also relates to a method for fertilizing target plants, wherein the end-use composition according to the invention is applied to target plants or to an environment for the target plants.

The present invention also relates to a process for manufacturing a composition according to the invention, which comprises mixing alkylthiophosphoric triamide, an additive and optionally at least one liquid carrier.

In one embodiment, in said process, the mixing forms a homogeneous liquid phase.

In one embodiment, in said process, the homogeneous liquid phase is formed at room temperature.

In one embodiment, said process comprises heating the mixture to form a homogeneous liquid phase.

The invention also relates to a liquid composition comprising at least 20 wt. %, preferably at least 27 wt. % relative to the total weight of the composition of alkylthiophosphoric triamide, said composition remaining flowable after storage at −16° C. for 12 weeks.

In one embodiment, said liquid composition comprises at most 29.9 wt. %, preferably at most 27 wt. % relative to the total weight of the composition of alkylthiophosphoric triamide.

The invention also relates to a liquid composition comprising at least 30 wt. %, relative to the total weight of the composition of alkylthiophosphoric triamide, said composition remaining flowable after storage at −10° C. for 12 weeks.

In one embodiment, said liquid composition comprises at most 35 wt. %, preferably at most 33 wt. % relative to the total weight of the composition of alkylthiophosphoric triamide.

In one embodiment, in any of said liquid compositions, the alkylthiophosphoric triamide is N-(n-butyl)thiophosphoric triamide (NBPT).

The invention also relates to the use of choline chloride as an additive for an agricultural composition, more particularly a fertilizer composition.

The invention relates in particular to the use of choline chloride as an additive for an agricultural composition comprising an alkylthiophosphoric triamide, more particularly a fertilizer composition, to form a eutectic mixture of at least the choline chloride and the alkylthiophosphoric triamide.

The invention also relates to a eutectic mixture consisting of or consisting essentially of 75 to 90 wt. %, preferably about 80 wt. % N-(n-butyl)thiophosphoric triamide (NBPT) and 10 to 25 wt. %, preferably about 20 wt. % choline chloride.

Any of these embodiments can be combined with one another. The invention will now be described in more detail.

In the present invention, the urease inhibitor of the type alkylthiophosphoric triamide that is used to prepare a composition according to the invention may be solid at its usual handling and/or storage temperature, which may range, for instance, from −20° C. to 35° C. In one embodiment it is solid at 0° C. In one embodiment it is solid at room temperature. The additive may be solid at its handling and/or storage temperature as well. In one embodiment, it is solid at 0° C. In one embodiment, the additive is solid at 14° C. In one embodiment the additive is solid at room temperature.

“Eutectic mixture” has its common meaning for the skilled person. Especially, it is understood to denote a mixture of at least two components which exists in a liquid state at a temperature below the melting point of any of the components of said eutectic mixture.

Generally, the eutectic mixture exists in a liquid state at a temperature of at least 1° C. below the melting point of the component with the lowest melting point in the eutectic mixture. Preferably, the eutectic mixture exists in a liquid state at a temperature of at least 5° C. below the melting point of the component with the lowest melting point in the eutectic mixture. More preferably, the eutectic mixture exists in a liquid state at a temperature of at least 15° C. below the melting point of the component with the lowest melting point in the eutectic mixture.

A particular case is a true eutectic mixture in which the proportions of the components of a given composition are such that the mixture exists in a liquid state at the lowest possible melting temperature (called eutectic temperature) over all of the mixing ratios for the involved components.

A eutectic mixture existing in a liquid state at room temperature is preferred. As used herein, “Room temperature” is understood to denote 25° C.

In one embodiment, the urease inhibitor, in particular the alkylthiophosphoric triamide and more particularly NBPT, is the component of the eutectic mixture having the lowest melting point. In another embodiment, the additive is the component of the eutectic mixture having the lowest melting point.

It is to be understood that the compositions of the present invention are not limited to binary mixtures of components capable of forming a eutectic mixture with one another: as it will be seen thereafter in the present description, the compositions of the present invention can additionally comprise several other ingredients than the at least two components suitable to form together a eutectic mixture.

The liquid state of a eutectic mixture described here before can be stable, which means that at a given temperature no solidification is observed over time.

According to one embodiment, the composition of the invention does not contain dimethylsulfoxide (DMSO).

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the term “alkoxyl” means an oxy radical that is substituted with an alkyl group, such as for example, methoxyl, ethoxyl, propoxyl, isopropoxyl, or butoxyl, which may optionally be further substituted on one or more of the carbon atoms of the radical.

As used herein, the term “alkoxyalkyl” means an alkyl radical that is substituted with one or more alkoxy substituents, more typically a (C₁-C₂₂)alkyloxy-(C₁-C₆)alkyl radical, such as methoxymethyl, and ethoxybutyl.

As used herein, the term “alkenyl” means an unsaturated straight or branched hydrocarbon radical, more typically an unsaturated straight, branched, (which, in one particular embodiment, is C₁-C₇₅) hydrocarbon radical, that contains one or more carbon-carbon double bonds, such as, for example, ethenyl, n-propenyl, iso-propenyl.

As used herein, the term “arylalkyl” means an alkyl group substituted with one or more aryl groups, more typically a (C₁-C₁₈)alkyl substituted with one or more (C₆-C₁₄) aryl substituents, such as, for example, phenylmethyl, phenylethyl, and triphenylmethyl.

As used herein, the term “aryloxy” means an oxy radical substituted with an aryl group, such as, for example, phenyloxy, methylphenyloxy, isopropylmethylphenyloxy.

As used herein, the terminology “(Cᵣ-Cₛ)” in reference to an organic group, wherein r and s are each integers, indicates that the group may contain from r carbon atoms to s carbon atoms per group.

Non-limiting examples of alkylthiophosphoric triamide urease inhibitors comprise any one or more of N-butyl thiophosphoric triamide (NBPT), N-propyl thiophosphoric triamide and cyclohexyl thiophosphoric triamide.

N-(n-butyl)-thiophosphoric triamide (“NBPT”) is particularly preferred as urease inhibitor. The purity of the urease inhibitor, in particular the alkylthiophosphoric triamide and more particularly the NBPT used in the compositions according to the invention is generally at least 95% by weight, preferably at least 97% by weight.

In the present invention, the additive is a component capable of forming a eutectic mixture with the alkylthiophosphoric triamide. Usually, the additive is environmentally acceptable and is preferably biodegradable. In one specific embodiment, it may be solid at 25° C.

Examples of additives include quaternary ammonium compounds, in particular salts of quaternary ammonium compounds. The quaternary ammonium compound may be selected from tetraalkyl ammonium compounds, especially those in which one or more of the alkyl radicals comprise at least one hydroxy group.

Particular examples of quaternary ammonium compounds include tributylalkylammonium chlorides, in particular tributylmethylammonium chloride.

Other particular examples of quaternary ammonium compounds include but are not limited to choline derivatives. Choline derivatives notably include the choline molecule as such, choline salts, and any chemically modified forms thereof. Especially, in one particular embodiment, the hydroxy group present in the choline moiety may be substituted by another chemical function such as, without being limited thereto, a carboxyl or carbonyl group; as well, in another embodiment, one or more of the methyl groups present in the choline moiety may be substituted by other groups, such as, without being limited thereto, one or more C₁-C₃₀ alkyl, alkenyl, alkynyl, cycloalkyl, aryl groups, which may be substituted and/or include one or more heteroatoms. Particular choline derivatives are selected from choline salts such as choline halides such as choline chloride, choline bitartrate, choline dihydrogencitrate, choline salicylate and choline methosulfate. Other particular choline derivatives are selected from any salt of choline-based chemical structures such as ethylcholine or allylcholine. Choline chloride is preferred as additive.

Other examples of additives include metal halide, in particular zinc chloride. Other examples of additives include amide derivatives, such as alkylamides, in particular acetamide.

In one embodiment, the composition of the invention comprises a complex of N-(n-butyl)thiophosphoric triamide (NBPT) and zinc chloride.

In another embodiment, the composition of the invention comprises a complex of N-(n-butyl)thiophosphoric triamide (NBPT) and acetamide.

In another embodiment, the composition of the invention comprises a complex of N-(n-butyl)thiophosphoric triamide (NBPT) and tributylmethylammonium chloride.

In the composition according to the invention, the weight ratio of urease inhibitor to solid additive is generally equal to or greater than 1:1. Preferably this ratio is equal to or greater than 2:1.

In the composition according to the invention, the weight ratio of urease inhibitor to solid additive is generally equal to or smaller than 10:1. Preferably this ratio is equal to or smaller than 5:1.

Preferred compositions according to the invention display an at least meta-stable liquid state at 18° C. Preferred compositions according to the invention display a stable liquid state at 42° C., preferably from 42° C. to 53° C.

While the invention will be more particularly illustrated with reference to N-(n-butyl)thiophosphoric triamide (NBPT) as urease inhibitor of the alkylthiophosphoric triamide type and choline chloride as additive, the skilled person is able to use the principle disclosed herein to identify further eutectic mixtures of urease inhibitors and additives, notably by heating mixtures of urease inhibitors and additives such as contemplated above, in particular including NBPT as urease inhibitor and observing their solidification behavior upon cooling below the lowest melting or decomposition temperature of each component of said mixture.

N-(n-butyl)thiophosphoric triamide (NBPT) and choline chloride form a binary eutectic mixture. Generally, the content of N-(n-butyl)thiophosphoric triamide (NBPT) in the eutectic mixture is equal to or greater than 70% by weight relative to the total weight of the eutectic mixture. Often, this content is equal to or greater than 72% by weight. Generally, the content of N-(n-butyl)thiophosphoric triamide (NBPT) is equal to or lower than 85% by weight relative to the total weight of the eutectic mixture. Often, this content is equal to or lower than 84% by weight. A content of N-(n-butyl)thiophosphoric triamide (NBPT) of about 80% by weight, for example 78 to 82% by weight relative to the total weight of the eutectic mixture gives good results.

Generally, the content of choline chloride in the eutectic mixture is equal to or greater than 15% by weight relative to the total weight of the eutectic mixture. Often, this content is equal to or greater than 16% by weight. Generally, the content of choline chloride is equal to or lower than 30% by weight relative to the total weight of the eutectic mixture. Often, this content is equal to or lower than 28% by weight. A content of choline chloride of about 20% by weight, for example 18 to 22% by weight relative to the total weight of the eutectic mixture gives good results.

In a particularly preferred aspect, the eutectic mixture consists of or consists essentially of about 80% by weight of NBPT and about 20% of choline chloride and has a melting point of about 42° C.

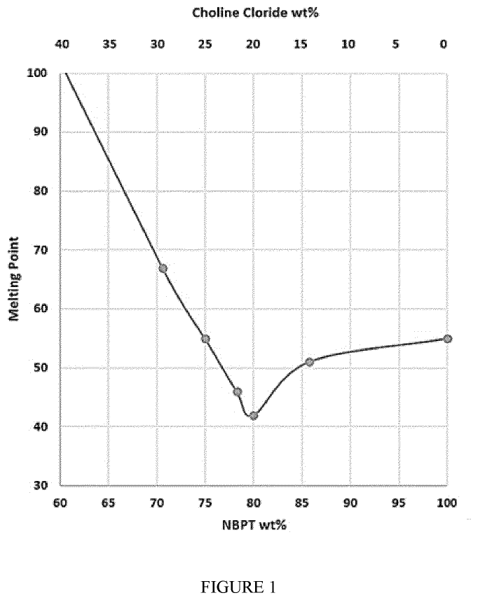

FIG. 1 shows the melting point diagram of mixtures of NBPT and choline chloride in function of their respective proportions.

Without wishing to be bound by any theory or explanation, it is believed that the formation of eutectic mixtures is supported by the formation of a complex of N-butylthiophosphoric triamide (NBPT) and choline chloride.

It has been found that the eutectic mixtures in accordance with the invention are highly advantageous for the formulation of agricultural compositions, especially fertilizer compositions. Notably, the dissolution of alkylthiophosphoric triamide in the composition at room temperature is facilitated, allowing to obtain homogeneous agricultural compositions which have high concentration of alkylthiophosphoric triamide. Said eutectic mixtures have also been proven useful as components of agricultural compositions having high thermal stability. Finally, it has been shown that said eutectic mixtures allow to provide agricultural compositions which have an excellent, albeit unprecedented cold stability.

In a first preferred embodiment of the composition according to the invention, the composition further comprises at least one liquid carrier.

It has been found that compositions of the first embodiment are advantageous in terms of facilitating a stable homogeneous liquid phase at room temperature and can provide stability of the composition at high and low temperatures.

In this embodiment, the liquid carrier suitably comprises or consists of at least one solvent which is usually selected from alcohols, glycols and glycol derivatives, amines, amine alcohols, heterocyclic alcohols, cyrene, dimethyl lactamide, dibasic ester solvents, toluene, trialkyl phosphate solvents, in particular triethyl phosphate, methylbenzoate, and from mixtures thereof. The liquid carrier may be in particular selected from heterocyclic alcohols.

Suitable heterocyclic alcohol solvents or co-solvents include, for example, 5- or 6-membered heterocyclic rings that include 1 or 2 oxygen atoms as ring member, that are substituted on at least one carbon atom of the ring with a (C₁-C₆) hydroxyalkyl group, and that may optionally be substituted on one or more carbon atoms of the ring with one or more (C₁-C₄)alkyl groups. It is understood that the term heterocyclic alcohol includes dioxolane compounds. In one embodiment, the heterocyclic alcohol component of the present invention comprises one or more compounds selected from heterocyclic alcohols according to structures (III), (IV), (V) and (VI):

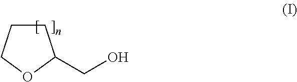

wherein n=1 or 2,

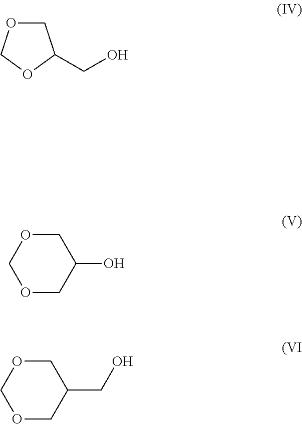 [SMILES: OCC1COCO1 ; OC1COCOC1 ; OCC1COCOC1]

Suitably the solvent may comprise or consists of at least one dioxolane compound of formula (I):

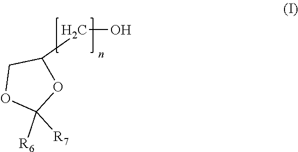

wherein R₆ and R₇ individually comprises a hydrogen, an alkyl group, an alkenyl group, a phenyl group, wherein n is an integer of from 1 to 14.

Particularly, the solvent may comprise or consist of at least one dioxolane compound of formula (I) in which: R₆ and R₇, which are identical or different, represent hydrogen or a C₁-C₁₄ group or radical. In one embodiment, R₆ and R₇ are individually selected from an alkyl group, alkenyl group or phenyl radical. In some embodiments, “n” is an integer of 1, 2, 3, 4, 5, 6, 7, 8, 9, 10, 11 or 12. Typically, “n” is an integer ranging from 1 to 4 or “n” is an integer ranging from 1 to 2.

In one particular embodiment, R₆ and R₇ are radicals individually selected from methyl, ethyl, n-propyl, isopropyl or isobutyl radical.

In one embodiment, the dioxolane compound of formula (I) is 2,2-diisobutyl-1,3-dioxolane-4-methanol (also known by the acronym IIPG, for the synonym 1-isobutyl-isopropylidene glycerol). In another embodiment, the dioxolane compound of formula (I) is 2,2-dimethyl-1,3-dioxolane-4-methanol.

In such a particular embodiment, the liquid carrier comprises or consists of Augeo® SL 191 DL-1,2-Isopropylideneglycerol of formula (VIII)

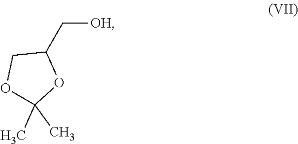

In a first aspect of this particular embodiment the composition according to the invention comprises or consists of from 25 to 29.9 wt. %, preferably from 27 to 29 wt. % of N-(n-butyl)thiophosphoric triamide (NBPT), from 4.5 wt. % to 8 wt. % preferably from 5 wt. % to 7 wt. % of choline chloride and more than 50 wt. %, and at most 70.5 wt. % of DL-1,2-Isopropylideneglycerol, relative to the total weight of the composition. The first aspect has particular advantages concerning very low temperature storage stability.

In a second aspect of this particular embodiment the composition according to the invention comprises or consists of from 30.0 to 35 wt. %, preferably from 30.5 to 33 wt. %, more preferably about 31 wt. % of N-(n-butyl)thiophosphoric triamide (NBPT), from 4.9 wt. % to 10 wt. % preferably from 7 wt. % to 8 wt. % more preferably about 7.5 wt. % of choline chloride and more than 40 wt. %, preferably at most 65.1 wt. % of DL-1,2-Isopropylideneglycerol. The second aspect has particular advantages in providing high load of alkylthiophosphoric triamide and good high temperature stability.

Suitable dibasic ester solvents useful as solvent or optional co-solvent include, for example, dialkyl esters of dicarboxylic acids, more typically, the di(C₁-C₁₂)alkyl esters of saturated linear or branched (C₂-C₈) aliphatic carboxylic acids or a mixture thereof. In one embodiment, the dibasic ester component comprises one or more compounds according to structure (II):

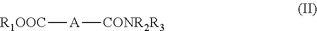

wherein:
A is a divalent linear or branched (C₂-C₈) aliphatic group, and
R₁, R₂, and R₃ are each independently (C₁-C₁₂)alkyl, (C₁-C₁₂) aryl, (C₁-C₁₂)alkaryl or (C₁-C₁₂) arylalkyl, and R₂ and R₃ may each optionally be substituted with one or more hydroxyl groups.

In one embodiment, the dibasic ester solvent or optional co-solvent component of the compositions and methods of the present invention comprises one or more dimethyl esters of saturated linear or branched (C₄-C₆) aliphatic carboxylic acids, such the dimethyl ester of succinic acid, dimethyl ester of ethyl succinic acid, the dimethyl ester of glutaric acid, the dimethyl ester of methyl glutaric acid, and the dimethyl ester of adipic acid, and mixtures thereof. In one embodiment, the dibasic ester component comprises the dimethyl ester of succinic acid, the dimethyl ester of glutaric acid, and optionally, the dimethyl ester of adipic acid, In another embodiment, the dibasic ester component comprises the dimethyl ester of ethyl succinic acid, the dimethyl ester of methyl glutaric acid, and optionally, the dimethyl ester of adipic acid.

In one embodiment, the dibasic ester solvent or optional co-solvent component of the compositions and methods of the present invention comprises one or more dialkyl esters of saturated linear or branched (C₄-C₆) aliphatic carboxylic acids, such the dialkyl ester of succinic acid, dialkyl ester of ethylsuccinic acid, the dialkyl ester of glutaric acid, the dialkyl ester of methylglutaric acid, and the dialkyl ester of adipic acid, and mixtures thereof. In one embodiment, the dibasic ester component comprises the dialkyl ester of succinic acid, the dialkyl ester of glutaric acid, and optionally, the dimethyl ester of adipic acid, In another embodiment, the dibasic ester component comprises the dialkyl dimethyl ester of ethylsuccinic acid, the dialkyl ester of methylglutaric acid, and optionally, the dialkyl ester of adipic acid. Each alkyl group in the dialkyl group, one embodiment, individually comprise a C₁-C₈ alkyl. In another embodiment, each alkyl group in the dialkyl group, one embodiment, individually comprise a C₁-C₄ alkyl. In another embodiment, each alkyl group in the dialkyl group, one embodiment, individually comprise a C₁-C₆ alkyl.

Compounds suitable as amine alcohol solvent or co-solvent component of the compositions and methods of the present invention are those compounds that comprise at least one primary, secondary, or tertiary amino moiety per molecule and at least one hydroxyalkyl moiety per molecule, more typically, in one embodiment, the amino alcohol is a linear, branched, or cyclic, saturated or unsaturated hydrocarbon that is substituted on at least one carbon atom with an amino group and on at least one other carbon atom with hydroxyalkyl or hydroxyl group, such as monoethanolamine, ethylaminoethanol, dimethylaminoethanol, isopropylaminoethanol, diethanolamine, triethanolamine, methylaminoethanol, aminopropanol, methylaminopropanol, dimethylaminopropanol, aminobutanol, dimethylaminobutanol, aminobutanediol, trihydroxymethylaminoethane, diethylaminopropanediol, 1-amino-cyclopentane methanol, and aminobenzyl alcohol, or a heterocyclic ring that comprises at least one nitrogen atom as a ring member and/or is substituted on at least one carbon atom with an amino group and that is substituted on at least one other carbon atom with a hydroxyalkyl or hydroxyl group, such as methylaminomethyl-1,3-dioxolane.

In one particular embodiment, the liquid carrier comprises or consists of an aminoalcohol, for example 3-amino-1-propanol. This particular embodiment has particular advantages providing cold stability for a high load of alkyl thiophosphoric triamide.

Generally, in this particular embodiment the composition according to the invention comprises or consists of from 30.0 to 35 wt. %, preferably from 30.5 to 33 wt. %, more preferably about 31 wt. % of N-(n-butyl)thiophosphoric triamide (NBPT), from 4.9 wt. % to 10 wt. % preferably from 7 wt. % to 8 wt. % more preferably about 7.5 wt. % of choline chloride and more than 40 wt. % and, preferably at most 65.1 wt. % of 3-amino-1-propanol.

Suitable glycols and glycol derivatives solvent or co-solvents include but are not limited to aliphatic dihydroxy (dihydric) alcohols. In one embodiment, glycol derivatives include but are not limited to polypropylene glycol, triethylene glycol, glycol alkyl ethers such as dipropylene glycol methyl ether, diethylene glycol. In another embodiment, glycol derivatives include but are not limited to polyglycols such as polyethylene glycols (PEG) and polypropylene glycols. Glycols are represented by the general formula CnH2n (OH) 2, where n is at least 2. Non-limiting examples of glycols include ethylene glycol (glycol), propylene glycol (1,2-propanediol), 1,4-butanediol, 1,5-pentanediol, 1,6-hexanediol, 1,7-heptanediol, 1,9-nonanediol, 1,10-decanediol, 1,8-octanediol, 1,3-propanediol, 1,3-butanediol, 1,4-butanediol, 2,3-butanediol, 2,4-pentanediol, 2,5-hexanediol, 4,5-octanediol and 3,4-hexanediol, neopenty glycol, pinacol, 2,2-diethyl-1,3-propanediol, 2-ethyl-1,3-hexanediol, 2-ethyl-2-butyl-1,3-propanediol, isobutylene glycol, 2,3-dimethyl-1,3-propanediol, 1,3-diphenyl-1,3-propanediol, 3-methyl-1,3-butanediol.

In another embodiment, glycol derivatives include but are not limited to glycol stearate, ethylene glycol monostearate, ethylene glycol distearate, ethylene glycol amido stearate, dilaurate glycol, propylene glycol monostearate, propylene glycol dicaprylate, propylene glycol dicaprate diacetate glycol, dipalmite glycol, diformate glycol, dibutyrate glycol, dibenzoate glycol, dipalmate glycol, dipropionate glycol, monoacetate glycol, monopalmitate glycol and monoformate glycol. In another embodiment, glycol derivatives also include polypropylene glycol, triethylene glycol, dipropylene glycol methyl ether, or diethylene glycol.

Polyglycol derivatives include but are not limited to polyethylene glycol (PEG) 200-6000 mono and dilaurates, such as, PEG 600 dilaurate, PEG 600 monolaurate, PEG 1000 dilaurate, PEG 1000 monolaurate, PEG 1540 dilaurate and PEG 1540 monolaurate, polyethylene glycol 200-6000 mono and dioleates, such as, PEG 400 monoleate, PEG 600 dioleate, PEG 600 monooleate, PEG 1000 monoleate, PEG 1540 dioleate, PEG 1540 monooleate and polyethylene glycol 200-6000 mono and distearates, such as, PEG 400 distearate, PEG 400 monostearate, PEG 600 distearate, PEG 600 monostearate, PEG 1000 distearate, PEG 1000 monostearate, PEG 1540 distearate, PEG 1540 monostearate and PEG 3000 monostearate.

In a preferred embodiment the composition further comprises an additional liquid carrier (co-solvent), preferably a (poly)alkylene ether, more preferably dipropylene glycol dimethyl ether.

Other preferred additional carriers are selected, for example, from aliphatic alcohols, in particular branched aliphatic alcohols having from 4 to 10 carbon atoms. 2-ethyl-1-hexanol is preferred.

When an additional liquid carrier is used, its content is generally from 1 to 10 wt. %, more particularly from 2 to 5 wt. % relative to the total weight of the composition. The use of an additional carrier especially as described here before has particular advantages in terms of allowing high and low temperature stability of the composition at high alkylthiophosphoric amide load and avoiding odor.

In certain aspects, the composition according to the invention may comprise a dye. Suitable dyes are commercially available, one example is Oracet® Blue 780 F. It has been found that the compositions according to the invention are compatible with dyes used in agricultural compositions. If a dye is used, its content is generally equal to or lower than 1% wt., preferably equal to or lower than 0.5% wt. relative to the total weight of the composition. If a dye is used, its content is generally sufficient to impart the desired coloration, for example equal to or more than 0.1% wt. relative to the total weight of the composition.

In the compositions according to the invention the content of alkythiophosphoric triamide is generally from 20 to 50 wt. %, preferably from 25 to 35 wt. %, more preferably about 30 wt. % relative to the total weight of the composition.

The composition according to the invention preferably remains flowable after keeping at a temperature of −10° C. for 3 weeks.

In one particular aspect, the invention relates to a liquid composition comprising at least 27 wt. %, relative to the total weight of the composition of alkythiophosphoric triamide, said composition remaining flowable after storage at −16° C. for 12 weeks. In this aspect, the composition generally comprises less than 30% by weight of alkythiophosphoric triamide.

In another particular aspect, the invention relates to a liquid composition comprising equal to or more than 30 wt. % relative to the total weight of the composition of alkythiophosphoric triamide, said composition remaining flowable after storage at −10° C. for 12 weeks. In this aspect, the composition generally comprises equal to or less than 35% by weight of alkythiophosphoric triamide.

The content of the alkythiophosphoric triamide in the liquid composition is generally equal to or lower than 35 wt. % relative to the total weight of the composition. Preferably this content is about 31% by weight.

In the liquid compositions described in the aspects here before, N-(n-butyl)thiophosphoric triamide (NBPT) is preferred as alkythiophosphoric triamide.

The invention also concerns an agricultural composition comprising an alkythiophosphoric triamide and an additive in proportions for which they form a eutectic mixture. Preferably the agricultural composition according to the invention comprises the composition according to the invention. The agricultural composition according to the invention generally further comprises a nitrogenous fertilizer. Non-limiting examples of nitrogenous fertilizers include urea, ammonium nitrate, or ammonium phosphate fertilizer compounds. Particular nitrogenous fertilizer compositions which can be included in the agricultural composition according to the invention include concentrated ammonium nitrate compositions, such as, for example, UAN 18, UAN 28, UAN 30 and UAN 32.

A particular embodiment of the agricultural composition according to the invention concerns an end-use composition. In one aspect the end-use composition is in solid state, for example in particulate or granular form or as a pellet, which comprises the agricultural composition according to the invention. More particularly, the end-use composition may comprise a core of nitrogenous fertilizer, as described above and a coating comprising the composition according to the invention.

In another aspect, the end-use composition is in liquid state. In that case it generally comprises or consists of a mixture or blend of a composition of the invention and of a liquid fertilizer, which can be in particular a concentrated ammonium nitrate composition as cited above. In that aspect, the amount of composition according to the invention is generally from 0.05 wt. % to 0.50 wt. % relative to the total weight of the end-use composition.

In another aspect, described herein are methods of making an aqueous end-use fertilizer composition comprising contacting one or more nitrogenous fertilizer compounds with an agricultural composition according to the invention and an aqueous medium, preferably water.

In another aspect, described herein are methods for fertilizing target plants, wherein the end-use composition according to the invention is applied to target plants or to an environment for the target plants. The end-use composition, in particular in its liquid state, can be used diluted with any appropriate solvent, such as water.

The invention also concerns a process for manufacturing the composition according to the invention or the agricultural composition according to the invention which comprises mixing a urease inhibitor of the alkylthiophosphoric triamide type, an additive and optionally at least one liquid carrier. In one aspect, the process according to the invention comprises mixing the urease inhibitor, the additive and one liquid carrier. In another aspect, the process according to the invention comprises mixing the urease inhibitor, the additive and at least two different liquid carriers. If appropriate, the process according to the invention comprises adding further functional additives such as for example one or more stabilizers and/or a dye.

Preferably, in the process according to the invention the mixing forms a homogeneous liquid phase. This is advantageous in terms of processing and storage of the composition while maintaining an adequate physical and chemical stability of the composition.

In one aspect, the homogeneous liquid phase is formed at room temperature. This aspect applies in particular when the composition according to the invention comprises at least one liquid carrier.

In another aspect, the process according to the invention comprises heating the mixture to form a homogeneous liquid phase. This aspect is advantageous when the composition consists essentially of urease inhibitor (alkylthiophosphoric triamide) and a solid additive.

Should the disclosure of any patents, patent applications, and publications which are incorporated herein by reference conflict with the description of the present application to the extent that it may render a term unclear, the present description shall take precedence. The examples hereafter are intended to further illustrate the invention without however limiting its scope.

### EXAMPLES

### Example 1—Binary Eutectics of NBPT and Choline Chloride

The solid NBPT (97% purity) and choline chloride were mixed in a flask and heated to 70° C.

Table 1 shows the compositions which were tested and the melting point of the binary mixtures. To eliminate freezing kinetic, each mixture was melted at 70° C. then left in the oven at the indicated temperature in column 3, Table 1, for 3 days. The temperature was reduced stepwise by 1° C. increments, until solids appear in the flasks. The temperature just before this step is labeled as the melting point.

TABLE 1

| | | Wt. ratio | Melting | |
|---|---|---|---|---|
| | wt. % | NBPT:ChCl | Point ° C. | Comments |
| 1 | {NBPT: 100 wt %/ChCl: 0 wt %} | 5.0:0.0 | 55 | Measured |
| 2 | {NBPT: 85.7 wt %/ChCl: 14.3 wt %} | 6.0:1.0 | 51 | Measured |
| 3 | {NBPT: 80 wt %/ChCl: 20 wt %} | 4.0:1.0 | 42 | Measured |
| 4 | {NBPT: 78.3 wt %/ChCl: 21.7 wt %} | 3.6:1.0 | 46 | Measured |
| 5 | {NBPT: 75 wt %/ChCl: 25 wt %} | 3.0:1.0 | 55 | Measured |
| 6 | {NBPT: 70.6 wt %/ChCl: 29.4 wt %} | 2.4:1.0 | 67 | Measured |
| L1 | {NBPT: 0 wt %/ChCl: 100 wt %} | 0.0:5.0 | 302 | From Literature |

### Example 2—Ternary Compositions Comprising a Eutectic Mixture of NBPT and Choline Chloride, Optionally Comprising a Dye

NBPT, Augeo® SL 191 solvent and if appropriate choline chloride and the dye Oracet® Blue 780 FE, in the proportions indicated in Table 2, were mixed and stirred at room temperature in a clean flask.

TABLE 2

| | Sample | | |
|---|---|---|---|
| | C1 | 7 (undyed) | 8 (dyed) |
| Ingredient name | wt. % | wt. % | wt. % |
| NBPT (97%) | 27.5 | 27.5 | 27.5 |
| Augeo SL 191 | 72.5 | 65.82 | 65.47 |
| Choline chloride | 0.00 | 6.68 | 6.68 |
| Oracet ® Blue 780 FE | 0.00 | 0.00 | 0.35 |
| Total | 100 | 100 | 100 |
| Initial Appearance | turbid liquid | clear liquid | blue liquid |
| 54° C. (2 weeks) | sedimentation | no sedimentation | no sedimentation |
| −16° C. (12 weeks) | frozen | flowable | flowable |

The compositions comprising NBPT and choline chloride in proportions for which they form a eutectic mixture provide a homogeneous liquid at room temperature and are superior in terms of high and low temperature stability compared to the control example C₁ without choline chloride. The dye is compatible with the choline chloride containing composition.

### Example 3—Ternary and Quaternary Compositions Comprising a Eutectic Mixture of NBPT and Choline Chloride, Optionally Comprising a Dye

To prepare sample 9, 30.9 g of NBPT (97%), 7.5 g Choline Chloride and 61.6 g of Augeo® SL 191 were added to a bottle and stirred for approximately 4 hours until a clear solution was obtained.

To prepare sample 10, 30.9 g of NBPT (97%), 7.5 g Choline Chloride, 56.6 g of Augeo® SL 191 and 5 g of Dipropylene glycol dimethyl ether were added to a bottle and stirred for approximately 4 hours until a clear solution was obtained.

To prepare sample 11, 30.9 g of NBPT (97%), 7.5 g Choline Chloride, 56.15 g of Augeo and 5 g of Dipropylene glycol dimethyl ether were added to a bottle and stirred for approximately 4 hours until a clear solution was obtained. Then 0.45 g of Oracet® Blue 780 FE dye was added to obtain the final formulation.

The stability was tested by keeping the liquid compositions at the temperature and for the time indicated in Table 3.

TABLE 3

| | Example | | |
|---|---|---|---|
| | 9 | 10 | 11 |
| Ingredient name | wt. % | wt. % | wt. % |
| NBPT (97%) | 30.9 | 30.9 | 30.9 |
| Choline Chloride powder | 7.5 | 7.5 | 7.5 |
| Augeo ® SL191 | 61.6 | 56.6 | 56.15 |
| Dipropylene glycol | 0 | 5 | 5 |
| dimethyl ether (DPGDME) | | | |
| Oracet ® Blue 780 FE | 0 | 0 | 0.45 |
| Total | 100 | 100 | 100 |
| Appearance at room | clear liquid | clear liquid | blue liquid |
| temperature | | | |
| 54° C. (2 weeks) | no sedimentation | no sedimentation | no sedimentation |
| −10° C. (12 weeks) | frozen, 3 weeks | flowable | flowable |

Example shows that the ternary composition 9 according to the invention is capable of carrying a high load of NBPT at room temperature and a good heat stability. The quaternary compositions 10 and 11 display in addition a good stability when kept at −10° C. The dye is compatible with the choline chloride containing composition 11.

### Example 4—Variation of Choline Chloride Content

These tests show the influence of varying the choline chloride content in a given composition. All tests were carried out at room temperature.

To prepare the control samples, 30.9 g of NBPT (97%), the indicated amounts of choline chloride (3 g, 15 g, 17.5 g), and Augeo® SL 191 (54.1 g, 51.6 g, 66.1 g) were added together and stirred in a clean bottle. NBPT and choline chloride did not completely dissolve.

To prepare sample 12, 30.9 g of NBPT (97%), 10 g choline chloride and 59.1 g of Augeo were added together and stirred in a clean bottle, NBPT and choline chloride not completely dissolved.

To prepare sample 13, 30.9 g of NBPT (97%), 7.5 g choline chloride and 61.6 g of Augeo were added in a clean bottle and stirred for approximately 4 hours until a clear solution was obtained.

To prepare sample 14, 30.9 g of NBPT (97%), 4.98 g choline chloride and 64.12 g of Augeo were added in a clean bottle and stirred for approximately 4 hours until a clear solution was obtained.

TABLE 4

| | Sample | | | | | |
|---|---|---|---|---|---|---|
| Ingredient | C2 | C3 | 12 | 13 | 14 | C4 |
| name | wt. % | wt. % | wt. % | wt. % | wt. % | wt. % |
| NBPT (97%) | 30.9 | 30.9 | 30.9 | 30.9 | 30.9 | 30.9 |
| Choline | 15 | 17.5 | 10 | 7.5 | 4.98 | 3 |
| Chloride | | | | | | |
| powder | | | | | | |
| Augeo ® | 54.1 | 51.6 | 59.1 | 61.6 | 64.12 | 66.1 |
| SL191 | | | | | | |
| Total | 100 | 100 | 100 | 100 | 100 | 100 |
| Initial | not | not | clear | clear | clear | cloudy |
| Appearance | dissolved | dissolved | liquid | liquid | liquid | |
| 54° C. | — | — | no | no | no | sedimentation |
| (2 weeks) | | | sedimentation | sedimentation | sedimentation | |
| −16° C. | — | — | frozen | frozen, >3 | frozen | frozen |
| (12 weeks) | | | | weeks | | |

In the ternary system of 30.9% NBPT, choline chloride and Augeo®, a choline chloride content of between 4.98 and 10 wt. % provides a clear solution of 30.9 wt. % NBPT at room temperature and a good heat stability, about 7.5 wt. % being the preferred composition.

### Example 5

TABLE 5

| | Sample | | | | | | | | |
|---|---|---|---|---|---|---|---|---|---|
| Ingredient | 15 | 16 | 17 | 18 | 19 | 20 | 21 | 22 | 23 |
| name | wt. % | wt. % | wt. % | wt. % | wt. % | wt. % | wt. % | wt. % | wt. % |
| NBPT (97%) | 30.9 | 30.9 | 30.9 | 30.9 | 30.9 | 30.9 | 30.9 | 30.9 | 30.9 |
| Choline | 7.5 | 7.5 | 7.5 | 7.5 | 7.5 | 7.5 | 7.5 | 7.5 | 7.5 |
| Chloride | | | | | | | | | |
| powder | | | | | | | | | |
| Augeo SL191 | 51.6 | ** | 59.6 | 56.6 | 54.6 | 56.6 | 51.6 | 51.6 | 56.6 |
| Cyrene | 10 | ** | ** | 5 | 5 | ** | ** | ** | ** |
| 3-amino-1- | ** | 61.6 | 2 | ** | 2 | ** | ** | ** | ** |
| propanol | | | | | | | | | |
| Dipropylene | ** | ** | ** | ** | ** | ** | ** | 10 | 5 |
| glycol | | | | | | | | | |
| dimethyl ether | | | | | | | | | |
| (DPGDME) | | | | | | | | | |
| 2 ethyl-1- | ** | ** | ** | ** | ** | 5 | 10 | ** | ** |
| hexanol | | | | | | | | | |
| Total | 100 | 100 | 100 | 100 | 100 | 100 | 100 | 100 | 100 |
| Initial | clear | clear | clear | clear | clear | clear | clear | clear | clear |
| Appearance | liquid | liquid | liquid | liquid | liquid | liquid | liquid | liquid | liquid |
| Odor | malodor | amine | amine | malodor | amine | no | no | no | no |
| | | odor | odor | | odor | | | | |
| 54° C. | yellow | amine | amine | yellow | amine | stable | stable | stable | stable |
| (2 weeks) | | odor | odor | | odor | | | | |
| −10° C. | frozen | flowable | frozen | frozen | frozen | frozen | frozen | frozen | flowable |
| (12 weeks) | | | | | | | | | |

All compositions 15 to 23 dissolve a high amount of NBPT (>30 wt. %) at room temperature. Compositions 20 to 23 illustrate additional advantages in terms of odor and heat stability. Compositions 16 and 23 illustrate an additional advantage of cold stability.

### Example 6—Tests with Various Additives

Other tests have been carried out to assess binary eutectics of NBPT and various additives. The procedure is the same as in Example 1.

The results are summarized in Table 6 below.

TABLE 6

| | | | DES Melting | |
|---|---|---|---|---|
| NBPT and additives | Wt. % | Wt. ratio | Point, ° C. | Comments |
| NBPT | 100:0 | 5:0 | 55 | from literature |
| NBPT:Choline | 85.71:14.29 | 6:1 | 51 | measured |
| chloride | 75:25 | 3:1 | 55 | measured |
| Choline chloride | 0:5 | 0:5 | 302 | from literature |
| NBPT:Choline | 85.71:14.29 | 6:1 | — | No DES |
| bitartrate | 75:25 | 3:1 | — | No DES |
| Choline bitartrate | 0:5 | 0:5 | 152 | from literature |
| NBPT:Choline | 85.71:14.29 | 6:1 | — | No DES |
| Dihydrogen Citrate | 75:25 | 3:1 | — | No DES |
| Choline Dihydrogen Citrate | 0:5 | 0:5 | 107 | from literature |
| NBPT:Magnesium | 85.71:14.29 | 6:1 | — | No DES |
| Chloride hexahydrate | 75:25 | 3:1 | — | No DES |
| Magnesium Chloride hexahydrate | 0:5 | 0:5 | 117 | from literature |
| NBPT:Tributylmethyl- | 85.71:14.29 | 6:1 | 41 | measured |
| ammonium chloride | 75:25 | 3:1 | 33 | measured |
| Tributylmethyl- | 0:5 | 0:5 | 43 | from literature |
| ammonium chloride | | | | |
| NBPT:Potassium | 85.71:14.29 | 6:1 | — | No DES |
| chloride | 75:25 | 3:1 | — | No DES |
| Potassium chloride | 0:5 | 0:5 | 770 | from literature |
| NBPT:Calcium | 85.71:14.29 | 6:1 | — | No DES |
| chloride dihydrate | 75:25 | 3:1 | — | No DES |
| Calcium chloride | 0:5 | 0:5 | 175 | from literature |
| dihydrate | | | | |
| NBPT:potassium | 85.71:14.29 | 6:1 | — | No DES |
| dihydrogen phosphate | 75:25 | 3:1 | — | No DES |
| potassium dihydrogen | 0:5 | 0:5 | 252 | from literature |
| phosphate | | | | |
| NBPT:3,4-Dimethylpyrazole | 85.71:14.29 | 6:1 | — | No DES |
| Phosphate (DMPP) | 75:25 | 3:1 | — | No DES |
| 3,4-Dimethylpyrazole | 0:5 | 0:5 | 168 | from literature |
| Phosphate (DMPP) | | | | |
| NBPT:Zinc chloride | 85.71:14.29 | 6:1 | 42 | measured |
| | 75:25 | 3:1 | 31 | measured |
| Zinc chloride | 0:5 | 0:5 | 290 | from literature |
| NBPT:Acetamide | 85.71:14.29 | 6:1 | 46 | measured |
| | 75:25 | 3:1 | 33 | measured |
| Acetamide | 0:5 | 0:5 | 81 | from literature |

In view of these results, the compositions comprising NBPT and choline chloride, NBPT and tributylmethylammonium chloride, NBPT and zinc chloride, and NBPT and acetamide, all lead to the formation of a eutectic mixture. In Table 6, the term “DES” means Deep Eutectic Solvent.

1. A composition comprising a eutectic mixture of an alkylthiophosphoric triamide and an additive.

2. The composition of claim 1, wherein the alkylthiophosphoric triamide is N-(n-butyl)thiophosphoric triamide (NBPT).

3. The composition according to claim 1, wherein the additive comprises a quaternary ammonium compound.

4. The composition of claim 3, wherein the quaternary ammonium compound is a salt.

5. The composition according to claim 3, wherein the quaternary ammonium compound is a choline derivative.

6. The composition according to claim 3, wherein the quaternary ammonium compound is a tributylalkylammonium chloride.

7. The composition according to claim 1, wherein the additive comprises a metal halide.

8. The composition according to claim 1, wherein the additive comprises an amide derivative.

9. The composition according to claim 1, wherein the weight ratio of alkylthiophosphoric triamide to additive is from 1:1 to 10:1.

10. The composition of claim 1, which further comprises at least one liquid carrier, selected from alcohols, glycols and glycol derivatives, amines, amine alcohols, heterocyclic alcohols, cyrene, dimethyl lactamide, dibasic ester solvents, toluene, and trialkyl phosphate solvents.

11. (canceled)

12. (canceled)

13. The composition of claim 10, wherein the liquid carrier comprises an aminoalcohol.

14. (canceled)

15. The composition of claim 10, wherein the composition further comprises an additional liquid carrier.

16. The composition according to claim 15, which contains 1 to 10 wt. % of dipropylene glycol dimethyl ether.

17. The composition according to claim 15, wherein the additional liquid carrier comprises an alkanol.

18. The composition according to claim 17, which contains 1 to 10 wt. % of 2-ethyl-1-hexanol.

19. The composition according to claim 1, wherein the eutectic mixture consists essentially of 75 to 90 wt. % of N-(n-butyl)thiophosphoric triamide (NBPT) and 10 to 25 wt. % of choline chloride.

20. An agricultural composition comprising a nitrogenous fertilizer, an alkylthiophosphoric triamide and an additive, said alkylthiophosphoric triamide and additive being in proportions for which they form a eutectic mixture.

21. (canceled)

22. (canceled)

23. (canceled)

24. A method for fertilizing target plants, wherein an end-use composition comprising a liquid or solid nitrogenous fertilizer and the composition according to claim 1, is applied to target plants or to an environment for the target plants.

25. A method comprising adding choline chloride as an additive to an agricultural composition.

26. The method according to claim 25, wherein choline chloride is used as an additive for an agricultural composition comprising an alkylthiophosphoric triamide, to form a eutectic mixture of at least the choline chloride and the alkylthiophosphoric triamide.
